(19) United States
(12) Patent Application Publication
(10) Pub. No.: US 2020/0148296 A1
(43) Pub. Date: May 14, 2020

(54) FOLDABLE BICYCLE CAPABLE OF BEING PUSHED EASILY

(71) Applicant: Chen Ching CHANG, New Taipei City (TW)

(72) Inventor: Chen Ching CHANG, New Taipei City (TW)

(21) Appl. No.: 16/189,271

(22) Filed: Nov. 13, 2018

(51) Int. Cl. B62K 15/00; B62K 21/16; B60B 33/06

(52) U.S. Cl. CPC B62K 15/008; B60B 33/066; B62K 21/16

(57) ABSTRACT

A foldable bicycle contains: a front frame, a rear frame, and a folding device. The front frame includes a front fork connected on a front wheel, and the rear frame includes a rear fork connected on a rear wheel and includes a seatpost coupled with a connection post and a saddle. The folding device is rotatably connected between the front frame and the second frame. The front fork has a sole column, the front wheel is inserted through a hub by using a hollow hub shaft to connect with the sole column, and the hollow hub shaft has a first connection element defined in a central portion thereof The rear wheel has a second connection element extending outward from a central portion thereof so as to fit with the first connection element after folding the front wheel and the second wheel.

### FIELD OF THE INVENTION

The present invention relates to a foldable bicycle which is capable of being pushed easily by ways of a universal wheel after being folded.

### BACKGROUND OF THE INVENTION

A conventional foldable bicycle is portable and is collapsible so as to overcome bulky weight as carrying the foldable bicycle. The foldable bicycle contains a frame and a support post having a rotary shaft so that two wheels erect on a ground after folding the foldable bicycle. The foldable bicycle further contains a seatpost used as its support point, but the foldable bicycle has following disadvantages:

1. When a folding device of the support post is a sole column, the foldable bicycle is collapsible in a V shape so the front wheel and the rear wheel are not parallel to each other, thus carrying and pushing the foldable bicycle difficultly.

2. When the folding device is double columns, the foldable bicycle is collapsible in a U shape so the front wheel and the rear wheel are parallel to each other, and a universal wheel is mounted on the frame so that the foldable bicycle erects on the ground by using the front wheel, the rear wheel, and the universal wheel. However, the front wheel and the rear wheel are not parallel to each other when pushing the foldable bicycle, thus damaging the folding device.

3. The front wheel and the rear wheel produce a torque force to the folding device so as to be folded oppositely. But the front fork and the rear fork of the frame are separated, a distance between the front and rear wheels is too long, so two connection elements are provided to connect the front and rear wheels, thus increasing weight and having troublesome assembly at high fabrication cost.

The present invention has arisen to mitigate and/or obviate the afore-described disadvantages.

### SUMMARY OF THE INVENTION

The primary objective of the present invention is to provide a foldable bicycle which is capable of being pushed easily by ways of a universal wheel after being folded.

To provide a foldable bicycle provided by the present invention contains: a front frame, a rear frame, and a folding device. The front frame includes a front fork connected on a front wheel, and the rear frame includes a rear fork connected on a rear wheel and includes a seatpost coupled with a connection post and a saddle.

The folding device is rotatably connected between the front frame and the second frame.

The front fork has a sole column, the front wheel is inserted through a hub by using a hollow hub shaft to connect with the sole column, and the hollow hub shaft has a first connection element defined in a central portion thereof

The rear wheel has a second connection element extending outward from a central portion thereof so as to fit with the first connection element after folding the front wheel and the second wheel.

### BRIEF DESCRIPTION OF THE DRAWINGS

FIG. 1 is a perspective view showing the assembly of a foldable bicycle according to a preferred embodiment of the present invention.

FIG. 2 is a perspective view showing the operation of the foldable bicycle according to the preferred embodiment of the present invention.

FIG. 3 is another perspective view showing the operation of the foldable bicycle according to the preferred embodiment of the present invention.

FIG. 4 is a perspective view showing the assembly of a part of the foldable bicycle according to the preferred embodiment of the present invention.

FIG. 5 is another perspective view showing the assembly of a part of the foldable bicycle according to the preferred embodiment of the present invention.

FIG. 6 is a cross sectional view showing the assembly of a part of the foldable bicycle according to the preferred embodiment of the present invention.

FIG. 7 is a cross sectional view showing the exploded components of a part of the foldable bicycle according to the preferred embodiment of the present invention.

FIG. 8 is a cross sectional view showing the operation of a part of the foldable bicycle according to the preferred embodiment of the present invention.

FIG. 9 is another cross sectional view showing the operation of a part of the foldable bicycle according to the preferred embodiment of the present invention.

FIG. 10 is also another perspective view showing the operation of the foldable bicycle according to another preferred embodiment of the present invention.

FIG. 11 is also another perspective view showing the assembly of a part of the foldable bicycle according to the preferred embodiment of the present invention.

FIG. 12 is another cross sectional view showing the assembly of a part of foldable bicycle according to the preferred embodiment of the present invention.

FIG. 13 is a perspective view showing the exploded components of a part of foldable bicycle according to the preferred embodiment of the present invention.

FIG. 14 is a perspective view showing the operation of a part of the foldable bicycle according to another preferred embodiment of the present invention.

FIG. 15 is still another perspective view showing the operation of the foldable bicycle according to another preferred embodiment of the present invention.

### DETAILED DESCRIPTION OF THE PREFERRED EMBODIMENTS

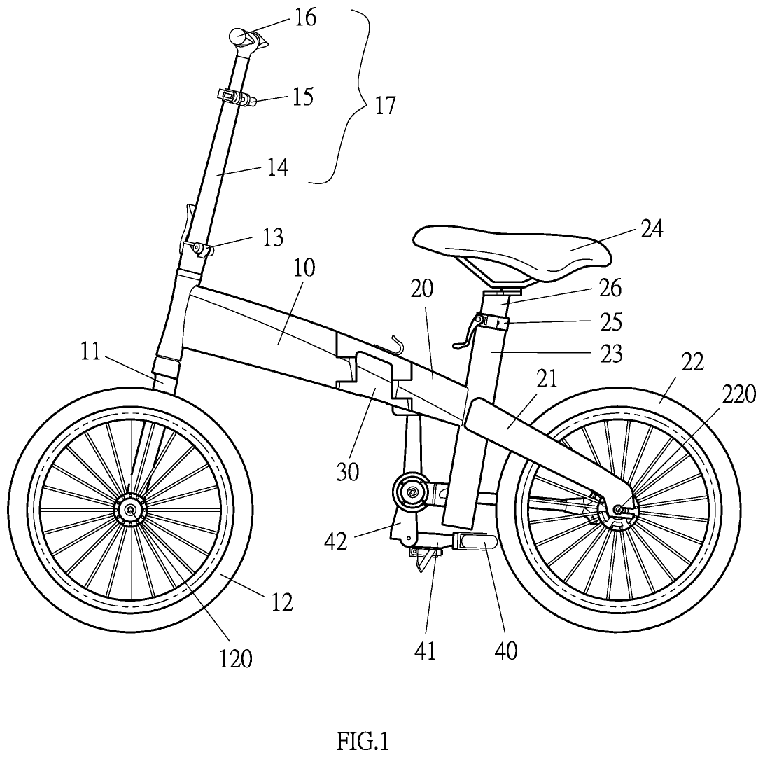

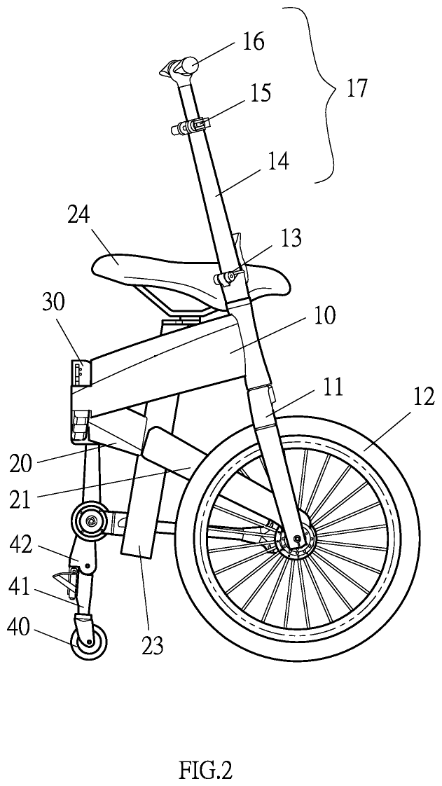

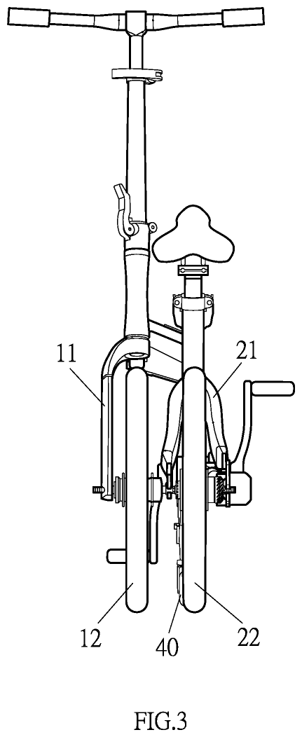

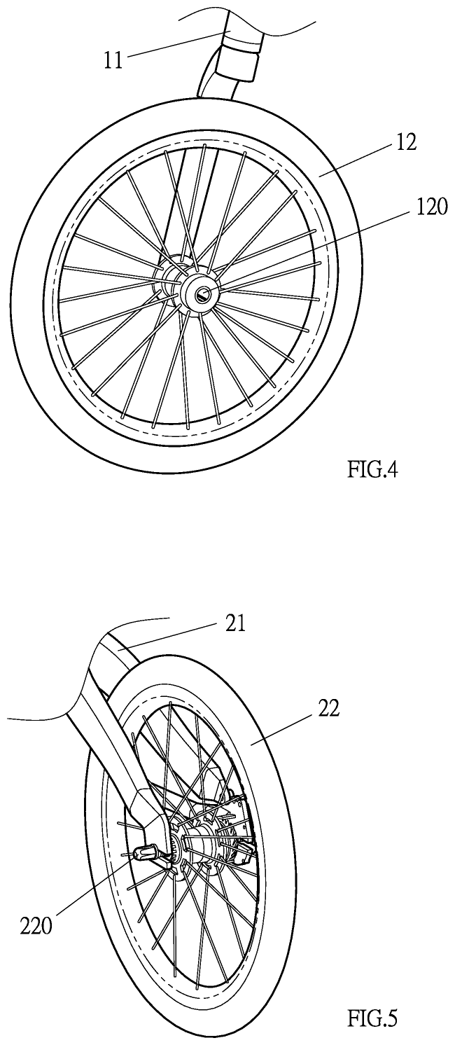

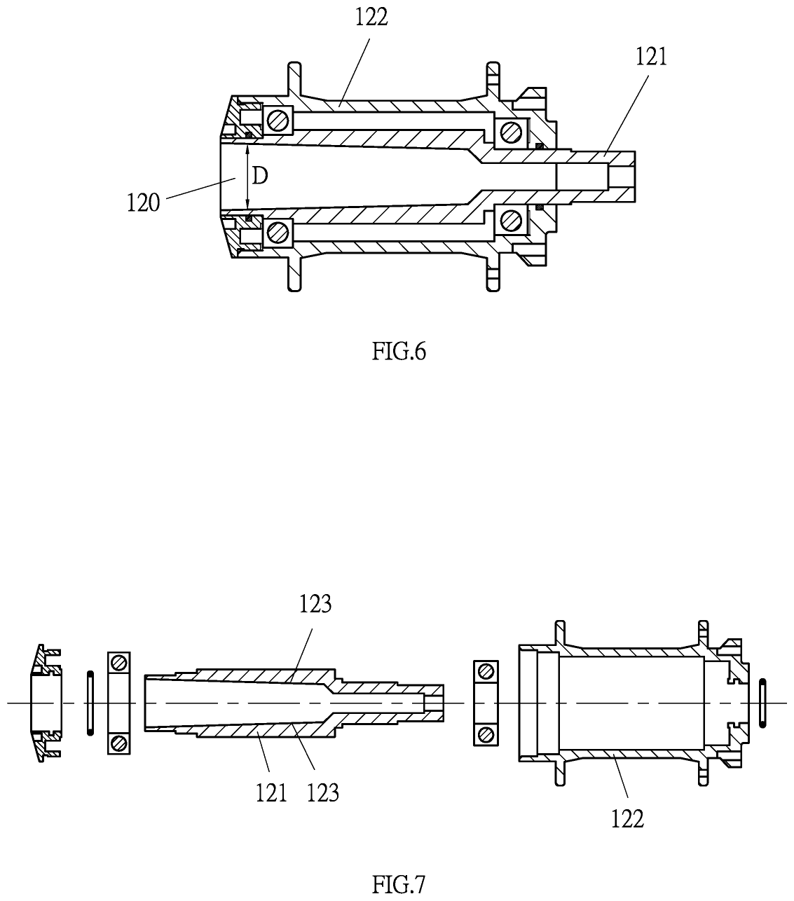

With reference to FIGS. 1-7, a foldable bicycle according to a preferred embodiment of the present invention comprises: a front frame 10 including a front fork 11 connected on a front wheel 12; a rear frame 20 including a rear fork 21 connected on a rear wheel 22 and a seatpost 23 coupled with a saddle 24; and a folding device 30 rotatably connected between the front frame 10 and the second frame 20 so that the front wheel 12 and the rear wheel 22 are parallel to each other after being folded. The front fork 11 has a sole column so as to reduce a weight of the foldable bicycle and a distance between the rear wheel 12 and the rear wheel 22 after folding the foldable bicycle. The front wheel 12 is inserted through a hub 122 by using a hollow hub shaft 121 to connect with the sole column 11, the hollow hub shaft 121 has a first connection element 120 defined in a central portion thereof, the rear wheel 22 has a second connection element 220 extending outward from a central portion thereof so as to fit with the first connection element 120 after folding the front wheel 12 and the second wheel 22, thus connecting and rotating the front wheel 12 and the rear wheel 22 coaxially.

When the hollow hub shaft 121 is a conventional quick-release hub shaft, a diameter of the hollow hub shaft 121 is 10 mm and is less than the second connection element 22, so that the hollow hub shaft 121 becomes bent after being hit, and the front wheel 12 and the rear wheel 22 are not connected coaxially. To overcome this problem, the diameter D of the hollow hub shaft 121 is more than the conventional quick-release hub shaft. Preferably, the diameter D of the hollow hub shaft 121 is more than 25 mm. An inner wall 123 of the hollow hub shaft 121 has a taper retracting inward from the inner wall 123 so that the front wheel 12 and the rear wheel 22 are connected coaxially. The hollow hub shaft 121 is heat treated (such as carburized) from chrome steel so as to decrease a thickness of the hollow hub shaft 121 and the weight of the foldable bicycle and to maintain strength of the foldable bicycle.

The rear frame 20 includes a universal wheel 40 mounted thereon so that the bicycle erects on a ground and is pushed by ways of the front wheel 12, the rear wheel 22, and the universal wheel 40 after being folded.

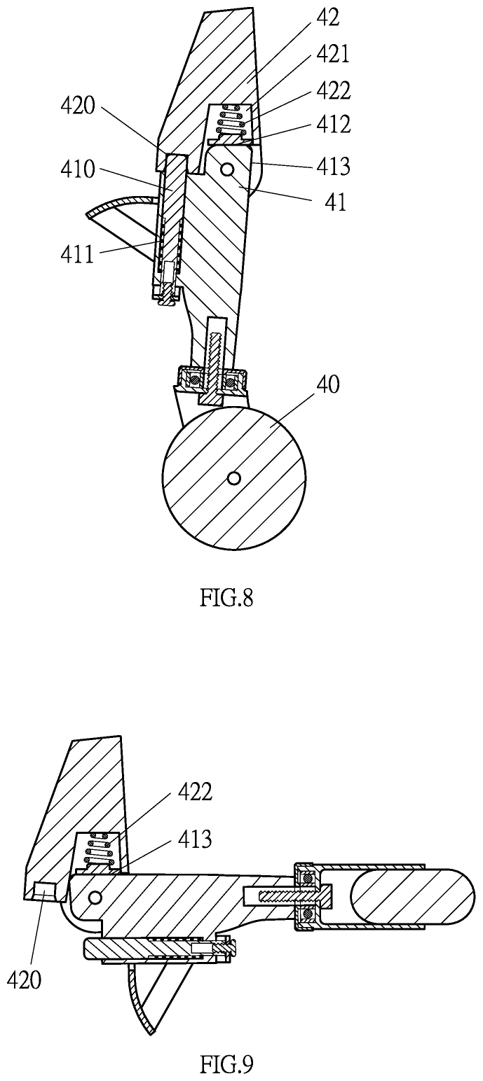

Referring further to FIGS. 1-3, 8, and 9, the universal wheel 40 includes a holder 42 disposed on the rear frame 20, and the holder 42 has a locking groove 420, a coupling groove 421, and a first resilient element 422 accommodated in the coupling groove 422. The universal wheel 40 is connected with a support post 41 which has a fixing stem 410, a second resilient element 411 rotatably fixed in the coupling groove 421 of the holder 42, a shoulder 412 and a ridge 413 which are formed on a rotatable connection portion of the support post 41 and the holder 42 so that when the universal wheel 40 is operated, the fixing stern 410 is pushed by the second resilient element 411 to retain with the locking groove 420, and the first resilient element 422 is engaged with the shoulder 412. When the universal wheel 40 is retracted, the first resilient element 422 is engaged with the ridge 413.

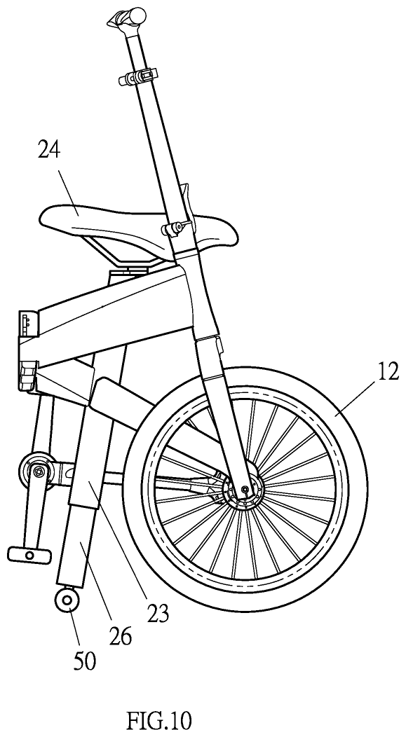

In another embodiment, a universal wheel 50 extends from the seatpost 23 of the rear frame 20, as shown in FIG. 10. The foldable bicycle further comprises a first quick-release element 25 mounted on a top of the seatpost 23, a connection post 26 accommodated in the seatpost 23, and a saddle 24 fixed on a top of the connection post 26, such that the first quick-release element 25 controls a vertical movement of the connection post 26 in the seatpost 23 so as to adjust a height of the saddle 24. Furthermore, the universal wheel 50 is secured on a bottom of the connection post 26, wherein when the foldable bicycle is folded, the universal wheel 50 touches the ground so as to push the foldable bicycle easily after moving the saddle 24 downward.

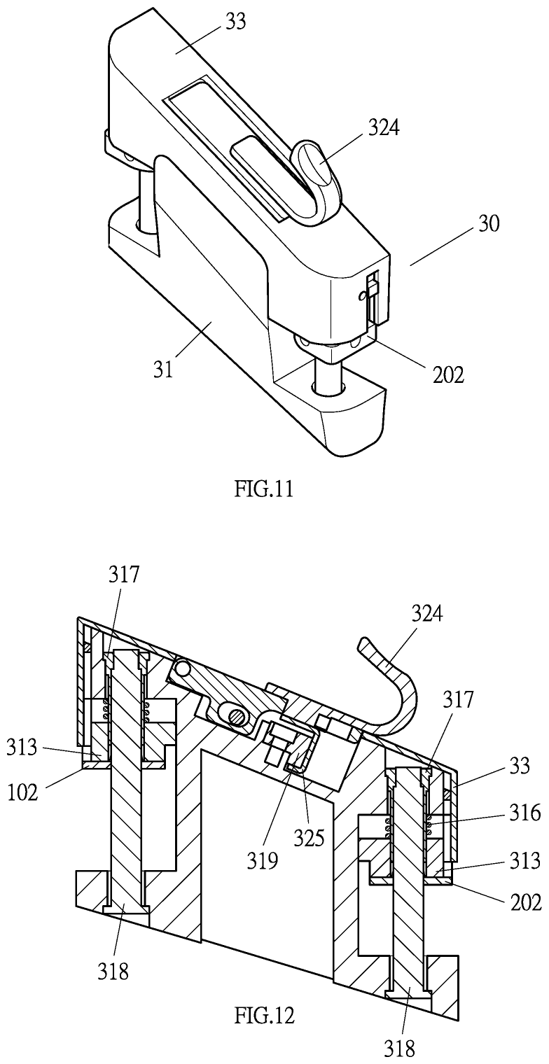

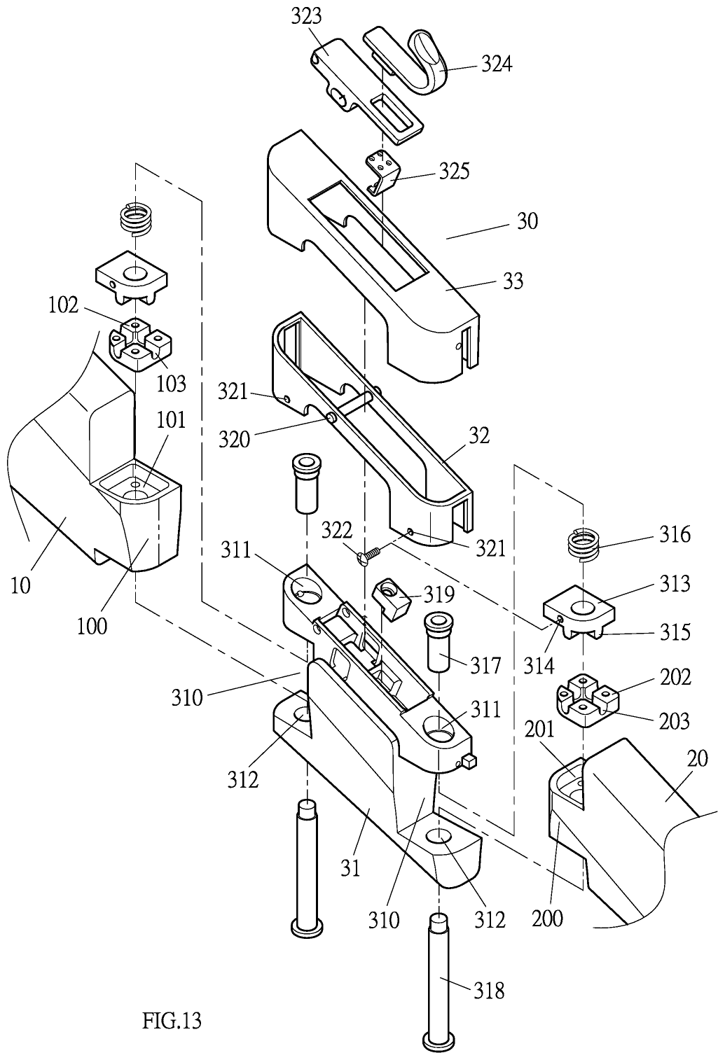

As illustrated in FIGS. 11-13, the front frame 10 includes a first affix portion 100, and the rear frame 20 includes a second affix portion 200, wherein the first affix portion 100 has a first trough 101 defined therein so as to accommodate a first positioning element 102, and the second affix portion 200 has a second trough 201 defined therein so as to accommodate a second positioning element 202.

The folding device 30 includes a rotatable connector 31, and the rotatable connector 31 has a protrusion 319 received in a central portion thereof, two receiving spaces 310 formed on two sides of the rotatable connector 31 respectively, two first through orifices 311 defined on two sides of a top of the rotatable connector 31 individually, and two second through orifices 312 defined on two sides of a bottom of the rotatable connector 31 respectively. The first affix portion 100 of the front frame 10 is housed in one of the two receiving spaces 310 of the rotatable connector 31, and the second affix portion 200 of the rear frame 20 is received in the other receiving space 310. The folding device 30 further includes two retaining elements 313 located above the first positioning element 102 and the second positioning element 202 respectively, two first threaded orifices 314 formed on two peripheral sides of the two retaining elements 313 individually, two tenon portions 315 formed on the two retaining elements 313 respectively so as to correspond to and to retain with a first recessed portion 103 and a second recessed portion 203 respectively. The rotatable connector 31 includes two springs 316 mounted above the two retaining elements 313 individually so as to contact with the first positioning element 102 and the second positioning element 202 respectively; two first rotary shafts 317 inserted through the two first through orifices 311 respectively, and two second rotary shafts 318 inserted through the two second through orifices 312 individually, such that the rotatable connector 31, the first affix portion 100, the second affix portion 200, the first positioning element 102, the second positioning element 202, and the two retaining elements 313 are rotatably connected; a slidable seat 32 fixed above the rotatable connector 31, wherein the slidable seat 32 has a shank 320 inserted in a central portion thereof and has two second threaded orifices 321 formed adjacent to two sides of the slidable seat 32 individually so that two screwing elements 322 lock the two retaining elements 313 on the slidable seat 32 respectively, and the two retaining elements 313 actuate the slidable seat 32; a control device 323 mounted on the shank 320 and having a controlling button 324 and a fastener 325, wherein the controlling button 324 controls the fastener 325 to fasten with or to remove from the protrusion 319; and a protective cap 33 configured to cover the slidable seat 32.

When the fastener 325 fastens with the protrusion 319, the two retaining elements 313 retain with the first positioning element 102 and the second positioning element 202 respectively so that the front frame 10 and the second frame 20 do not rotate relative to the folding device 30. When the controlling button 324 is pulled to drive the fastener 325 to detach from the protrusion 319, the slidable seat 32 and the two retaining elements 313 move upward relative to the rotatable connector 31 so that the two tenon portions 315 of the two retaining elements 313 remove from the first recessed portion 103 of the first positioning element 102 and the second recessed portion 203 of the second positioning element 202 respectively, and the front frame 10 and the rear frame 20 rotate relative to the folding device 30. When the front frame 10 and the rear frame 20 are revolved in a U shape, the slidable seat 32 and the rotatable connector 31 are fixed, thus folding the front frame 10 and the second frame 20 in the U shape.

The first recessed portion 103 of the first positioning element 102 and the second recessed portion 203 of the second positioning element 202 are formed in a cross shape, and the two tenon portions 315 of the two retaining elements 313 are formed in the cross shape so as to correspond to the first recessed portion 103 and the second recessed portion 203, thus rotating the front frame 10 and the rear frame 20 to 90 degrees relative to the folding device 30.

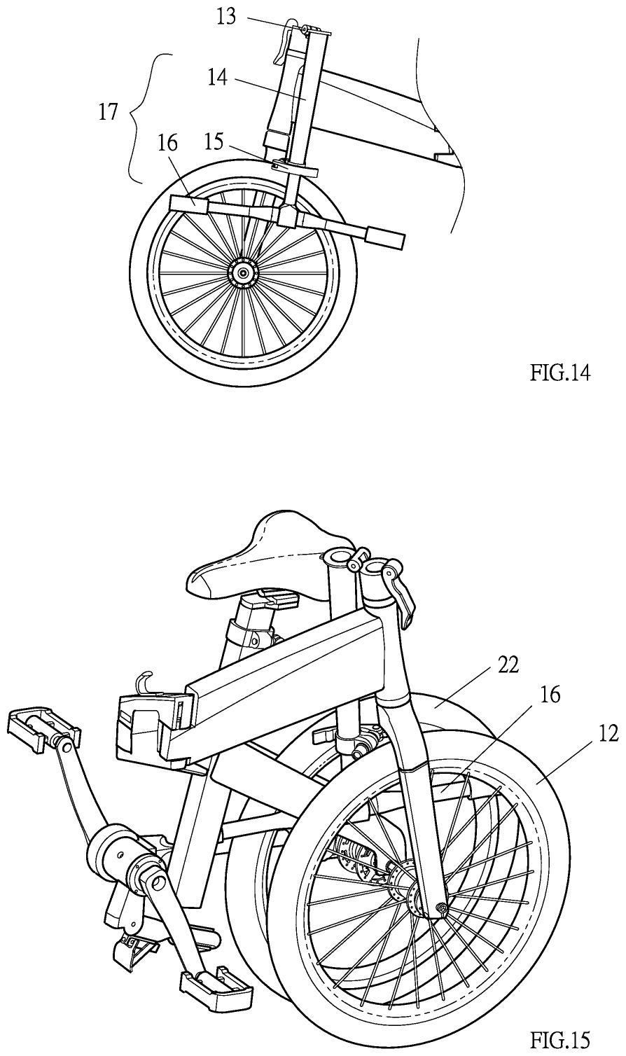

With reference to FIGS. 14 and 15, the front frame 10 further includes a second quick-release element 13 connected on a head tube 17, wherein the heat tube 17 has a vertical part 14 on which a third quick-release element 15 is mounted, and a horizontal handlebar 16 connected with the third quick-release element 15, such that the head tube 17 is collapsible between the front wheel 12 and the rear wheel 22 after folding the foldable bicycle.

Thereby, the foldable bicycle has advantages as follows:

1. It is easy to fold the foldable bicycle after the controlling button is pulled so that the second connection element fits with the first connection element, thus connecting and rotating the front wheel and the rear wheel coaxially. Thereafter, the universal wheel is dropped to fold the foldable bicycle in three seconds, and the foldable bicycle is pushed quickly.

2. The universal wheel is maintained horizontally and does not interrupt the front wheel, thus pushing the foldable bicycle smoothly.

3. The distance among the rear wheel, the rear wheel, and the universal wheel is 30 cm so as to reduce a rotation radius of the foldable bicycle to 30 cm, thus manually pushing the handlebar or the saddle to drive the foldable bicycle to move easily.

4. The front wheel and the rear wheel are connected securely when pushing the foldable bicycle to reduce a torque force, an abrasion, and a replacement frequency of the folding device.

5. The two tenon portions of the two retaining elements retain with or remove from the first recessed portion of the first positioning element and the second recessed portion of the second positioning element respectively so as to control the front frame and the rear frame to rotate. It is easy to replace the first positioning element, the second positioning element, and the two retaining elements after a period of using time, thus decreasing replacement cost.

6. The head tube is collapsible between the front wheel and the rear wheel after folding the foldable bicycle, thus reducing a folding size of the foldable bicycle.

It is to be noted that related gears, chains, brakes, pedals, and wheel rims of the foldable bicycle are well-known prior art, so further remarks are omitted.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A foldable bicycle comprising:
a front frame including a front fork connected on a front wheel;
a rear frame including a rear fork connected on a rear wheel and a seatpost coupled with a connection post and a saddle;
a folding device rotatably connected between the front frame and the second frame so that the front wheel and the rear wheel are parallel to each other after being folded;
wherein the front fork has a sole column, and the front wheel is inserted through a hub by using a hollow hub shaft to connect with the sole column, the hollow hub shaft has a first connection element defined in a central portion thereof;
wherein the rear wheel has a second connection element extending outward from a central portion thereof so as to fit with the first connection element after folding the front wheel and the second wheel.

2. The foldable bicycle as claimed in claim 1, wherein an inner wall of the hollow hub shaft has a taper retracting inward from the inner wall.

3. The foldable bicycle as claimed in claim 1 further comprising:
a holder disposed on the rear frame, and the holder having a locking groove, a coupling groove, and a first resilient element accommodated in the coupling groove;
a support post having a fixing stem, a second resilient element rotatably fixed in the coupling groove of the holder, a shoulder and a ridge which are formed on a rotatable connection portion of the support post and the holder; and
a universal wheel connected with a support post;
wherein when the universal wheel is operated, the fixing stem is pushed by the second resilient element to retain with the locking groove, and the first resilient element is engaged with the shoulder;
wherein when the universal wheel is retracted, the first resilient element is engaged with the ridge.

4. The foldable bicycle as claimed in claim 2 further comprising:
a holder disposed on the rear frame, and the holder having a locking groove, a coupling groove, and a first resilient element accommodated in the coupling groove;
a support post having a fixing stem, a second resilient element rotatably fixed in the coupling groove of the holder, a shoulder and a ridge which are formed on a rotatable connection portion of the support post and the holder; and
a universal wheel connected with a support post;
wherein when the universal wheel is operated, the fixing stem is pushed by the second resilient element to retain with the locking groove, and the first resilient element is engaged with the shoulder;
wherein when the universal wheel is retracted, the first resilient element is engaged with the ridge.

5. The foldable bicycle as claimed in claim 3, wherein the universal wheel is secured on a bottom of the connection post.

6. The foldable bicycle as claimed in claim 4, wherein the universal wheel is secured on a bottom of the connection post.

7. The foldable bicycle as claimed in claim 1, wherein the front frame includes a first affix portion, and the rear frame includes a second affix portion, wherein the first affix portion has a first trough defined therein so as to accommodate a first positioning element, and the second affix portion has a second trough defined therein so as to accommodate a second positioning element;
wherein the folding device includes:
a rotatable connector having a protrusion received in a central portion of the rotatable connector, two receiving spaces formed on two sides of the rotatable connector respectively, two first through orifices defined on two sides of a top of the rotatable connector individually, and two second through orifices defined on two sides of a bottom of the rotatable connector respectively;
two retaining elements located above the first positioning element and the second positioning element respectively, two first threaded orifices formed on two peripheral sides of the two retaining elements individually, and two tenon portions formed on the two retaining elements respectively so as to correspond to and to retain with a first recessed portion and a second recessed portion respectively;
two springs mounted above the two retaining elements individually so as to contact with the first positioning element and the second positioning element respectively;
two first rotary shafts inserted through the two first through orifices respectively, and two second rotary shafts inserted through the two second through orifices individually, such that the rotatable connector, the first affix portion, the second affix portion, the first positioning element, the second positioning element, and the two retaining elements are rotatably connected;
a slidable seat fixed above the rotatable connector, wherein the slidable seat has a shank inserted in a central portion thereof and has two second threaded orifices formed adjacent to two sides of the slidable seat individually so that two screwing elements lock the two retaining elements on the slidable seat respectively, and the two retaining elements actuate the slidable seat;
a control device mounted on the shank and having a controlling button and a fastener;
wherein the controlling button controls the fastener to fasten with or to remove from the protrusion; and a protective cap configured to cover the slidable seat.

8. The foldable bicycle as claimed in claim 7, wherein the first recessed portion of the first positioning element and the second recessed portion of the second positioning element are formed in a cross shape, and the two tenon portions of the two retaining elements are formed in the cross shape so as to correspond to the first recessed portion and the second recessed portion.
